(19) United States
(12) Patent Application Publication
(10) Pub. No.: US 2024/0157723 A1
(43) Pub. Date: May 16, 2024

(54) SEALING RING, HUB CAP SYSTEM AND VEHICLE

(71) Applicant: SAF-HOLLAND GmbH, Bessenbach (DE)

(72) Inventor: Daniel Müller, Aschaffenburg (DE)

(21) Appl. No.: 18/508,544

(22) Filed: Nov. 14, 2023

(30) Foreign Application Priority Data
Nov. 14, 2022 (DE) 10 2022 130 084.6

(51) Int. Cl. B60B 7/00; F16J 15/02

(52) U.S. Cl. CPC B60B 7/0013; F16J 15/025

(57) ABSTRACT

A sealing ring includes a retaining portion and a primary sealing lip, the retaining portion extending circumferentially around an axial direction, a radial direction extending radially and perpendicularly away from the axial direction, the primary sealing lip having an extension in the positive radial direction, the primary sealing lip having a pressure side in the direction of the axial direction.

### BACKGROUND

The invention relates to a sealing ring, a hub cap system for attachment to a wheel hub of a vehicle, a wheel cap system comprising a wheel hub and a hub cap system, and a vehicle, in particular a commercial vehicle.

Among other things, hub cap systems have the task of protecting an inner area of a wheel and/or a wheel hub against the ingress of foreign bodies or particles and/or liquids, e.g. dirt or moisture. In order to achieve a better sealing effect, it is known from the prior art to provide sealing rings between the hub cap and the wheel hub to improve a seal against the penetration of foreign bodies. However, if the wheels are equipped with a tire pressure regulation system, the sealing effect achieved can be potentially unfavorable if compressed air enters the wheel hub, for example due to leakage in the supply lines of the tire pressure regulation system. If the interior of the wheel hub is sealed to the outside, this can lead to a buildup of excess pressure, which in turn can cause damage to the hub system or even cause the hub cap to be lost or detached.

It is therefore a task of the invention to provide a sealing ring as well as a corresponding hub cap system with which, with sufficient sealing against the ingress of dirt or moisture, pressure compensation of the interior pressure in the wheel hub is possible in a simple manner and which enable assembly that is as simple and inexpensive as possible.

### SUMMARY

According to the invention, a sealing ring comprises a retaining region and a primary sealing lip, the retaining region being formed circumferentially about an axial direction, a radial direction extending radially and perpendicularly away from the axial direction, the primary sealing lip having an extension in the positive radial direction, the primary sealing lip having a pressure side, in particular in the direction of the axial direction. The axial direction designates in particular a direction perpendicular to the surface spanned by the sealing ring. The axial direction or the central axis preferably runs through the center of the sealing ring. The radial direction runs in particular from the center point or center axis of the sealing ring or the axial direction radially outward and/or perpendicular to the axial direction. The center of gravity of the sealing ring is preferably on the axial direction. In this context, a positive radial direction may be understood to be a direction that extends radially outward from the center point or center axis of the sealing ring, while a negative radial direction may be understood to be a direction that points radially from outwards to the center point or center axis of the sealing ring. The sealing ring may have a substantially constant cross-section and/or a cross-section that is predominantly constant or constant in sections, in particular in a direction transverse to the axial direction and transverse to the radial direction, hence for example in a circumferential direction. The circumferential direction can thereby form the angular coordinate in a cylinder coordinate system, the axial direction the axial coordinate and the radial direction the radial coordinate. In this context, substantially constant means in particular that the sealing ring has a constant cross-section apart from design-related deviations and/or grooves. Predominantly or sectionally constant can mean that the sealing ring has a substantially constant cross-section, but deviates from this constant cross-section in places, e.g. by at least one aperture or groove. Advantageously, the sealing ring may be formed in one piece. A one-piece design can enable a particularly reliable sealing effect and, if necessary, prevent assembly errors due to incorrect assembly. For example, the sealing ring can be elastically tightened at the location of its intended use. The sealing ring has a retaining region, the retaining region in particular comprising an abutment region of the sealing ring, for example against a hub cap and/or against a wheel hub, and/or being designed to abut against, for example, a hub cap and/or against a wheel hub. The retaining region may be a base body, which constitutes or may constitute the majority of the mass and/or volume of the sealing ring. The retaining region may have an approximately rectangular cross-section, and/or wherein, for example, the corners of the retaining region may be rounded, and/or wherein the retaining region may deviate from the rectangular cross-sectional shape on a side where the primary sealing lip is arranged or formed and/or adjoining the retaining region. The retaining region and/or the sealing ring can comprise recesses, depressions and/or openings or bores, which can serve in particular for the conduction and/or residence of air. The retaining region is arranged circumferentially about an axial direction and/or about a central axis of the sealing ring. The primary sealing lip may adjoin the retaining region or be placed next to each other. Alternatively, the primary sealing lip may be spaced from the retaining region. For example, a transition region may be provided between the retaining region as well as the primary sealing lip. The primary sealing lip can preferably be of elastic design. Preferably the retaining region and/or the primary sealing lip is made of the same material. Advantageously, the retaining region is materially bonded to the primary sealing lip, whereby a particularly high mechanical load-bearing capacity and sealing effect can be achieved. A specified extension of the primary sealing lip can refer in particular to a relaxed, i.e. in particular non-elastically deformed, state of the primary sealing lip. An extension of the primary sealing lip refers in particular to an extension along the main extension or the longest extension of the primary sealing lip in a sectional plane spanned by the axial direction and the radial direction. The primary sealing lip can extend proportionally in a further direction in addition to the radial direction, e.g. in the axial direction. Accordingly, the extension of the primary sealing lip has at least one component in the radial direction. Optionally, the extension of the primary sealing lip may have a further component in another direction. For example, the primary sealing lip may extend obliquely to the radial direction. A direction of extension of the primary sealing lip is thereby dimensioned in particular from its attachment to the other components of the sealing ring, in particular the retaining region, to its distal end. An extension in the positive direction can mean that the primary sealing lip extends radially outward from its attachment to the sealing ring away from the center of the sealing ring or the axial direction or the center axis of the sealing ring. In particular, a distal end of the primary sealing lip may be further away from the center of the sealing ring or the axial direction than the root of the primary sealing lip. The primary sealing lip may present or form the distal end of the sealing ring in a first direction, particularly in the radial direction. The primary sealing lip can be designed to prevent foreign bodies, in particular dirt and/or water, from entering the interior space, in particular at a pressure in the interior space which is below a predetermined threshold pressure. In addition, the primary sealing lip can be designed to allow pressure to be released by flexing back in the event of excess pressure in the interior above the predetermined threshold pressure. The bending back of the primary sealing lip can be conditioned in particular by the pressure in the interior space. In other words, the primary sealing lip can be designed to provide a sealing effect at normal pressure and to enable overpressure compensation by flexible bending back when a pressure threshold is exceeded. The sealing effect of the primary sealing lip can be achieved in particular by contact of the primary sealing lip with a surface, for example a hub cap and/or a wheel hub. Advantageously, the sealing ring according to the invention can be used, for example, to prevent the ingress of dirt and/or water, in particular through the primary sealing lip, on the one hand, and, on the other hand, if necessary, to allow venting of excess pressure, for example leakage pressure, from an interior space, in particular through the primary sealing lip. In particular, the inner space is the space whose fluid is in contact with the pressure side of the sealing ring. In other words, the interior space is that space whose pressure acts on the pressure side of the sealing ring. The inner space can in particular be the inner space of a wheel hub and/or a hub cap. In particular, the primary sealing lip surrounds the axial direction. In other words, the primary sealing lip can form a ring around the axial direction. In this way, a particularly good mechanical load capacity can be achieved.

Advantageously, the primary sealing lip can extend from the retaining region. In other words, the primary sealing lip can be directly adjacent to the retaining region. This can result in a particularly simple and compact design of the sealing ring.

Advantageously, the primary sealing lip and/or the retaining region and/or the sealing ring can be made of rubber and/or of a plastic, in particular to a predominant part, especially preferably completely. Advantageously, the sealing ring can be made entirely of rubber and/or a plastic. To a predominant part can mean here that the sealing ring comprises, for example, a, in particular outer, protective layer and/or an inclusion and/or an outer additive made of another material. Alternatively or additionally, the sealing ring may comprise an admixture of another material. To a predominant extent may in particular mean that the sealing ring is formed of more than 50 percent, preferably more than 80 percent, of rubber and/or of a plastic, in particular with respect to the weight or volume of the sealing ring. If other materials are added so that the sealing ring consists of more than 50 percent rubber and/or a plastic, the sealing ring can have particularly good stability and/or particularly good protection against environmental influences. A design consisting of more than 80 percent rubber and/or of a plastic can provide particularly good elasticity and/or tightness of the sealing ring. A complete design made of rubber and/or a plastic can furthermore enable relatively inexpensive and/or simple manufacture.

Preferably, a deformation space is provided between the primary sealing lip and the retaining region, wherein the deformation space is advantageously formed, in particular rotationally symmetrically, circumferentially about the axial direction. The deformation space is in particular a free space. The deformation space can serve to provide a deformation option when pressure is applied to the primary sealing lip. The rotationally symmetrical design of the deformation space means that particularly good mechanical load-bearing capacity can be achieved.

Suitably, the primary sealing lip extends in the axial direction and in the radial direction. In other words, the primary sealing lip can extend obliquely to the axial direction and to the radial direction. This type of extension may allow the primary sealing lip to be in particularly good sealing contact with a surface, such as a wheel hub. Advantageously, the primary sealing lip may extend substantially equally in the axial direction and in the radial direction, where “substantially” may mean a deviation of at most 10 percent from a similar extension in these two directions. It has been found that such a uniform design can, on the one hand, achieve a particularly good sealing effect and, on the other hand, that opening of a venting path can be achieved by elastic bending of the primary sealing lip with only a small bending, in particular smaller in comparison with a non-oblique alignment.

Preferably, the sealing ring, especially in the primary sealing lip, has grooves extending in the radial direction. These grooves allow pressurization of the pressure side of the primary sealing lip to be ensured. This applies in particular even if the pressure side of the primary sealing lip is partially in contact with the wheel hub or another component. In particular, the course of the groove is at least substantially parallel to the radial direction. The groove therefore runs exclusively in the radial direction, except for deviations due to production. This makes it possible to achieve a particularly small fluid path and thus keep the “pressure loss” in the groove low.

Advantageously, the grooves extend from the retaining region into the primary sealing lip and/or the grooves have a rounded groove base, in particular in a radial plane. By designing the grooves in such a way that they extend, in particular in each case, from the retaining region to the primary lip, it is possible to achieve particularly good fluid guidance. Therefore, a sufficient flow cross-section is available for inflow and outflow. The groove bottom is in particular the bottom of the groove, hence the bottom of the groove. Advantageously, the bottom of the groove is rounded. In this way, a mechanically stable and loadable design can be achieved—especially with dynamic loads. Advantageously, the rounded center of the groove base—viewed in the axial direction—is located on the pressure side of the primary sealing lip. The radial plane is in particular a plane that is defined by the axial direction and the radial direction.

Preferably, the grooves are arranged equidistant to each other in the circumferential direction. In this way, a uniform pressure distribution can be achieved, since the grooves can serve as a kind of flow channel. By an equidistant arrangement to one another it is to be understood in particular that the angular spacing between the directly adjacent grooves is the same. Therefore, the grooves are therefore all arranged with an equal angular spacing to the respective adjacent grooves.

In particular, the grooves are arranged on the pressure side of the primary sealing lip. In this way, the grooves can be used particularly advantageously to cause or promote venting in the event of excess pressure on the pressure side, in particular by deforming the primary sealing lip.

Advantageously, the sealing ring has only one sealing lip or one circumferential sealing lip, namely the primary sealing lip. This makes it possible to achieve a particularly cost-effective design.

Preferably, the primary sealing lip is designed in such a way that when pressure is applied to the pressure side, the primary sealing lip is deformed towards the retaining region. In other words, the primary sealing lip can therefore be designed in such a way that when pressure is applied above a threshold value on the pressure side, the primary sealing lip yields due to this pressure by moving in the direction of the retaining region or part of the retaining region.

Advantageously, the primary sealing lip limits the sealing ring in the radial direction. In other words, the primary sealing lip forms the distal end in the radial direction of the sealing ring. This makes it possible to achieve particularly simple contact between the sealing ring and a contact partner, in particular a wheel hub.

Advantageously, the retaining region may have a bottom surface, the bottom surface preferably being coaxial with the axial direction and/or preferably facing the central axis of the sealing ring. In other words, the bottom surface can have a normal in the direction of the radial direction. In this way, a particularly good mounting possibility of the retaining region can be achieved.

Advantageously, the primary sealing lip can be formed to extend completely around the axial direction. In particular, a cross-section transverse to the axial direction and the radial direction of the primary sealing lip can be formed to be constant. A formation extending completely around the axial direction may allow easy manufacturing. In addition, the sealing ring or the primary sealing lip can thus be particularly mechanically resilient. Furthermore, by running completely around, a uniform release of overpressure can be realized.

According to a further aspect of the invention, there is provided a hub cap system for attachment to a wheel hub of a vehicle, in particular a commercial vehicle, comprising a hub cap and a sealing ring as described herein. A commercial vehicle within the meaning of the invention is, in particular, a vehicle having a gross vehicle weight of more than 3.5 t, preferably of more than 7.5 t and particularly preferably of more than 18 t. The commercial vehicle may in particular be a roadworthy vehicle and/or a road-bound vehicle. Preferably, such a commercial vehicle may be a trailer, in particular a semi-trailer. All the advantages and features of the sealing ring can be transferred analogously to the hub cap system and vice versa. The sealing ring according to the invention can serve for venting an inner space of the wheel hub and/or the hub cap or a wheel in case of overpressure, in particular by means of the primary sealing lip, wherein the sealing ring simultaneously provides protection of the inner space against dirt and/or water or other liquids, in particular by means of the primary sealing lip.

Advantageously, the hub cap has a compressed air feed-through arrangement. This compressed air feed-through arrangement serves to guide compressed air out of the interior of the hub cap. In particular, the flow channel of the compressed air feed-through arrangement is arranged in an opening in the hub cap. Advantageously, the center of this aperture or of the or a flow channel of the compressed air feed-through arrangement lies on the axial direction. The compressed air feed-through arrangement therefore extends at least in particular from an inner side of the hub cap to an outer side of the hub cap. The compressed air feed-through arrangement may have a connection for an air guide device, in particular a hose. This connection may in particular have or be a thread. Advantageously, the direction of extension of the connection is aligned parallel to the radial direction. This saves valuable installation space in particular. The connection is used to be connected to a tire interior, in particular using the air guide system. This forms a tire inflation system through which the tire can be filled with compressed air.

Advantageously, the hub cap can have a fastening region, in particular a groove, wherein the fastening region advantageously runs around the axial direction or center axis of the sealing ring, and/or wherein optionally the fastening region is advantageously formed pointing away from the axial direction or a center axis of the sealing ring, and wherein the sealing ring, in particular the retaining region of the sealing ring, is arranged on or in the fastening region. Pointing away from the axial direction can mean in particular that the fastening region is arranged on a side of the hub cap facing in the positive radial direction. The fastening area, in particular the groove, can advantageously serve to stabilize the arrangement of the sealing ring or ensure or facilitate the correct arrangement of the sealing ring during installation.

Advantageously, the hub cap can have or at least partially enclose an interior space. In other words, at least one volume is provided in the interior of the hub cap, which can serve as a storage location for compressed air energy or as a storage space for compressed air.

Another aspect of the invention may relate to a hub cap system. Preferably, the hub cap system comprises a wheel hub and/or a sealing ring as described above or below and/or a hub cap system as described above or below. Advantageously, the primary sealing lip is in contact with the wheel hub or can be in contact with the wheel hub and/or wherein the hub cap is reversibly fixed to the wheel hub, in particular via a click lock. The contact of the primary sealing lip with the wheel hub can effectively prevent fluid flow through the gap between the wheel hub and the hub cap. In particular, this contact can be made in such a way that the contact surface between the primary sealing lip and the wheel hub forms or can form a closed ring. In this way, fluid loss can be prevented, in particular completely. By fastening the hub cap to the wheel hub by means of a click fastener, a particularly simple and fast assembly can be achieved. Basically, the assembly can be carried out by means of any reversible fastening, but a click fastener can be assembled particularly quickly and easily, in particular without tools. The click fastener has, in particular on the side of the hub cap, which can also be referred to fundamentally (irrespective of the embodiment) as a hub cap, deformable form-fitting means, in particular in the direction of the axial direction, which can interact or cooperate with complementary form-fitting means on the mounting partner, in particular the wheel hub, in such a way that disassembly is prevented in a form-fitting manner. The complementary form-fitting means can be lugs and recesses. Extending in the radial direction, the lugs can form the distal end in the axial direction of the hub cap.

According to a further aspect of the invention, a vehicle, in particular a commercial vehicle, is provided comprising a sealing ring as described herein, a hub cap system as described herein and/or a wheel hub system as described herein. All advantages and features of the sealing ring, the hub cap system and the wheel hub system can be transferred analogously to the vehicle and vice versa.

Individual features and embodiments mentioned above may be combined with each other, and the advantages associated with the individual features also apply to a combination of these features.

Further advantages and features of the invention will be apparent from the following description of preferred embodiments of the subject matter of the invention with reference to the accompanying figures. The following description serves only to clarify the invention and should not be construed as limiting the appended claims to any of the embodiments. Showing

### BRIEF DESCRIPTION OF THE DRAWINGS

FIG. 1 is a sectional view of a wheel hub system according to one embodiment of the invention;

FIG. 2 is an enlarged sectional view of the sealing ring of the area Z, FIG. 1; and

FIG. 3 is an isometric view of the sealing ring.

### DETAILED DESCRIPTION OF THE PREFERRED EMBODIMENTS

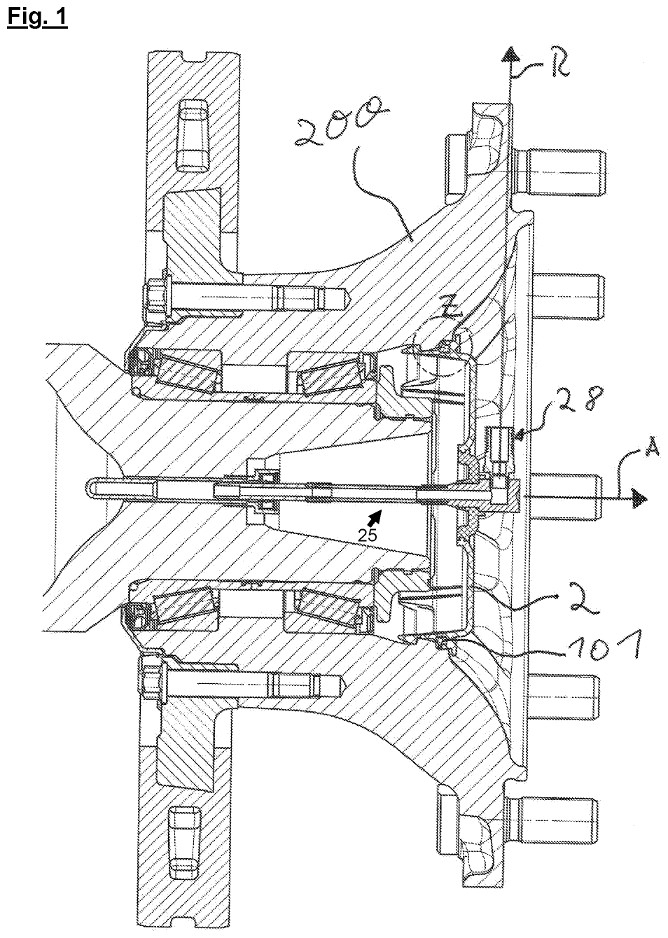

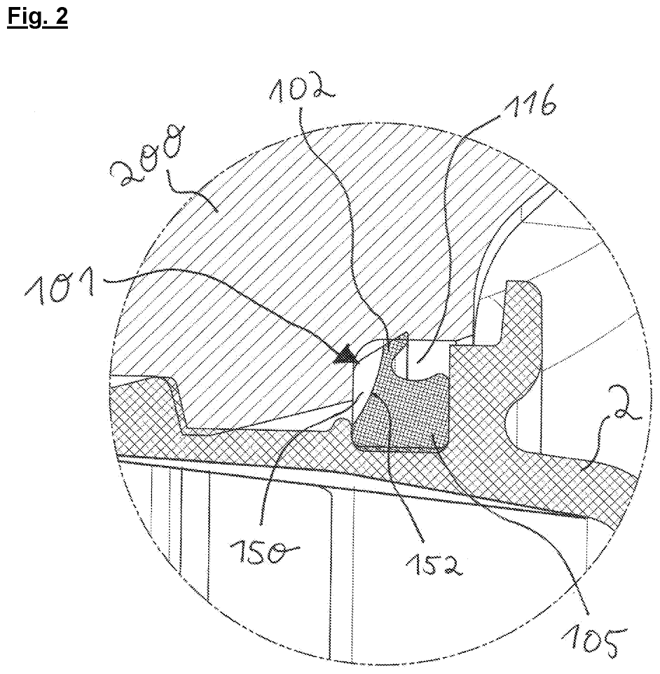

FIG. 1 shows a sectional view of a wheel hub system. The wheel hub system has a hub cap 2 and a sealing ring 101 and a wheel hub 200. The sealing ring 101 is arranged in the space between the hub cap 2 and the wheel hub 200. The detail area shown with dashed circle in FIG. 1, which is also marked with Z, is shown in FIG. 2 for further explanation. The hub cap 2 has a compressed air passage arrangement 25 in a central aperture, which has a flow channel extending along the axial direction A. The air passage arrangement 25 is arranged in the center of the hub cap 2. Radially pointing away from the axial direction A is the radial direction R. The connection 28 of the compressed air feed-through arrangement 25 extends in the radial direction R. In terms of flow, the compressed air feed-through arrangement 25 connects the connection 28 or its connection 28 to the interior of the axle and/or of an axle stub, which can also be part of the wheel hub system.

FIG. 2 shows a detailed view of a section through a sealing ring 101, where a hub cap 2 and a wheel hub 200 are also cut at the same time. The sectional plane is spanned by the radial direction R and the axial direction A. The sealing ring 101 is formed in an annular shape around the axial direction A. The sealing ring 101 has a primary sealing lip 102 that abuts and/or can abut against the wheel hub 200. In addition, the sealing ring 101 also has a retaining portion 105 which serves to retain the sealing ring 101 against the hub cap 200. In order to be able to form a pressure on the primary seal 102 and, at the same time, also to be able to realize a high sealing effect by means of a large contact surface between the primary seal 102 and the wheel hub 200, the sealing ring 102 has grooves 150 which can extend in the radial direction R. The grooves 150 have a tapered shape. The grooves 150 have a rounded groove base 152.

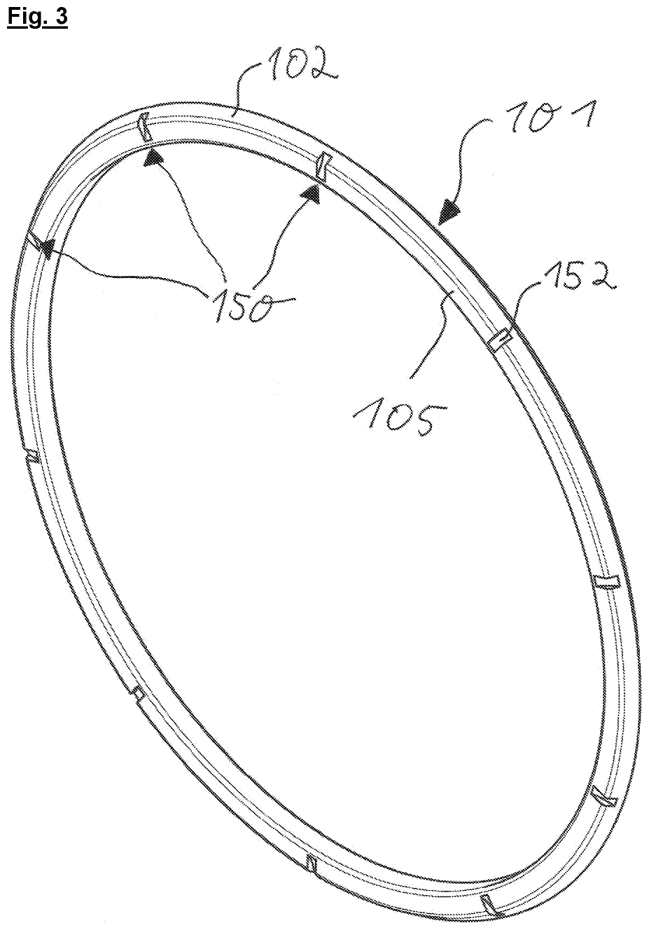

FIG. 3 shows an isometric view of a sealing ring 101. The sealing ring 101 in turn has a retaining region 105, which is joined to the primary sealing lip 102 by a material bond, this material bond having been achieved in the example shown by forming the primary sealing lip 102 in one piece with the retaining region 105. Both the primary sealing lip 102 and the retaining region 105 annularly surround the axial direction A. The sealing ring 101 shown in FIG. 3 has a plurality of grooves 150 which are arranged equidistantly from each other in a circumferential direction.

### LIST OF REFERENCE SIGNS

2 Hub cap
25 Compressed air feed-through arrangement
28 Connection
101 Sealing ring
102 Primary sealing lip
105 Holding range
116 Deformation space
150 Groove
152 Groove base
200 Wheel hub
A Axial direction
R Radial direction
Z detail area

The invention claimed is:

1. A sealing ring comprising:
a retaining region extending circumferentially about an axial direction (A); and a primary sealing lip having an extension in a positive radial direction, wherein the radial direction extends radially and perpendicularly away from the axial direction, and wherein the primary sealing lip has a pressure side in the direction of the axial direction.

2. The sealing ring according to claim 1, wherein a deformation space is located between the primary sealing lip and the retaining region, and wherein the deformation space extends rotationally symmetrically, circumferentially about the axial direction.

3. The sealing ring according to claim 2, wherein the primary sealing lip extends in the axial direction and in the radial direction.

4. The sealing ring according to claim 3, wherein the sealing ring has grooves extending in the radial direction.

5. The sealing ring according to claim 4, wherein the grooves extend from the retaining region into the primary sealing lip and/or wherein the grooves have a rounded groove base in a radial plane.

6. The sealing ring according to claim 4, wherein the grooves are arranged on the pressure side of the primary sealing lip.

7. The sealing ring according to claim 6, wherein the primary sealing lip is configured such that when pressure is applied to the pressure side the primary sealing lip is deformed toward the retaining region.

8. The sealing ring according to claim 1, wherein the primary sealing lip extends in the axial direction and in the radial direction.

9. The sealing ring according to claim 1, wherein the sealing ring has grooves extending in the radial direction.

10. The sealing ring according to claim 9, wherein the grooves extend from the retaining region into the primary sealing lip and/or wherein the grooves have a rounded groove base in a radial plane.

11. The sealing ring according to claim 9, wherein the grooves are arranged on the pressure side of the primary sealing lip.

12. The sealing ring according to claim 1, wherein the primary sealing lip is configured such that when pressure is applied to the pressure side, the primary sealing lip is deformed toward the retaining region.

13. A hub cap system for attachment to a wheel hub of a commercial vehicle, comprising:
the sealing ring according to claim 1; and
a hub cap having a compressed air feed-through arrangement, that extends in the axial direction.

14. The wheel hub system comprising the hub cap system according to claim 13 and a wheel hub, wherein the primary sealing lip abuts or is configured to abut the wheel hub and/or wherein the hub cap is reversibly fixed to the wheel hub via a click lock.

15. A commercial vehicle, comprising the sealing ring according to claim 1.

16. A commercial vehicle, comprising:
a sealing ring, comprising:
a retaining region extending circumferentially about an axial direction; and
a primary sealing lip having an extension in a radial direction, wherein the radial direction extends radially and perpendicularly away from the axial direction, and wherein the primary sealing lip has a pressure side in the direction of the axial direction; and
a hub cap having a compressed air feed-through arrangement that extends in the axial direction.

17. The commercial vehicle according to claim 16, wherein a deformation space is located between the primary sealing lip and the retaining region, and wherein the deformation space extends rotationally symmetrically, circumferentially about the axial direction.

18. The commercial vehicle of claim 17, wherein the primary sealing lip extends in the axial direction and in the radial direction.

19. A commercial vehicle, comprising:
a sealing ring comprising:
a retaining region extending circumferentially about an axial direction; and
a primary sealing lip having an extension in a radial direction, wherein the radial direction extends radially and perpendicularly away from the axial direction, and wherein the primary sealing lip has a pressure side in the direction of the axial direction; and
a hub cap system, comprising:
a hub cap having a compressed air feed-through arrangement that extends in the axial direction; and
a wheel hub, wherein the primary sealing lip abuts or is configured to abut the wheel hub and/or wherein the hub cap is reversibly fixed to the wheel hub via a click lock.

20. The commercial vehicle according to claim 16, wherein a deformation space is located between the primary sealing lip and the retaining region, and wherein the deformation space extends rotationally symmetrically, circumferentially about the axial direction.
